(19) United States
(12) Patent Application Publication
(10) Pub. No.: US 2026/0092213 A1
(43) Pub. Date: Apr. 2, 2026

(54) DESTRUCTION OF PFAS IN SOIL

(71) Applicant: Battelle Memorial Institute, Columbus, OH (US)

(72) Inventors: Kavitha DASU, Powell, OH (US); Samer Mohamad AL-DIRANI, Columbus, OH (US); Dinusha Prasadani SIRIWARDENA, Davis, CA (US)

(73) Assignee: BATTELLE MEMORIAL INSTITUTE, Columbus, OH (US)

(21) Appl. No.: 19/345,387

(22) Filed: Sep. 30, 2025

Related U.S. Application Data
(60) Provisional application No. 63/701,431, filed on Sep. 30, 2024.

(51) Int. Cl. C09K 17/02; C09K 17/06

(52) U.S. Cl. CPC C09K 17/02; C09K 17/06

(57) ABSTRACT

A method and system for the destruction of per- and polyfluoroalkyl substances (PFAS) in soil is disclosed. The method includes introducing a soil composition including PFAS into a sealed reactor vessel. An oxidant may be introduced into the reactor vessel, and the soil composition may be dosed with the oxidant to form a dosed soil composition, where the dosed soil composition is a soil slurry that includes between 20 wt % and 50 wt % solids. An alkaline additive may be introduced into the reactor vessel. The reactor vessel may then be pressurized to a pressure at or above 2,000 psi and heated to a temperature at or above 350° C. The dosed soil composition and alkaline additive may be maintained under the reactor pressure and reactor temperature for a reaction period sufficient to destruct more than 90 weight percent of the PFAS present in the dosed soil composition.

### CROSS-REFERENCE TO RELATED PATENT APPLICATIONS

This application claims priority to U.S. Appl. Ser. No. 63/701,431, filed Sep. 30, 2024, entitled “Systems And Methods For Treatability Testing to Destroy PFAS in Soil Using Supercritical Water Oxidation,” which patent application is commonly owned by the owner of the present invention. This patent application is incorporated herein in its entirety.

### TECHNICAL FIELD

The present disclosure relates to per- and polyfluoroalkyl substances (PFAS), a class of synthetic fluorinated compounds that are persistent in the environment and difficult to degrade using conventional treatment technologies. Specifically, the present disclosure relates to systems and methods for the destruction of PFAS present in soil or other solid matrices. The present disclosure further relates to the application of supercritical water oxidation (SCWO) and subcritical water oxidation processes for the destruction of PFAS in soil, sludge, and other PFAS-impacted solid materials. In particular, the present disclosure encompasses systems, apparatuses, and methods configured to oxidize PFAS in soil matrices using oxidants and alkaline additives under elevated temperature and pressure conditions to achieve high degrees of PFAS destruction and defluorination.

### BACKGROUND

Perfluoroalkyl and polyfluoroalkyl substances (PFAS) comprise a broad class of highly fluorinated organic compounds characterized by strong carbon-fluorine bonds that resist thermal, chemical, and biological degradation. Historical and ongoing use of PFAS in aqueous film-forming foams (AFFF), textiles, coatings, and industrial processes has led to widespread environmental releases. As a result, PFAS have been detected in soils, sediments, and associated vadose-zone materials at industrial facilities, municipal sites, and Department of Defense (DoD) installations.

Remedial investigations and soil management activities at PFAS-impacted sites generate substantial volumes of investigation-derived waste (IDW), including excavated soils, drill cuttings, and dewatering residuals. In many cases, these solid matrices contain a heterogeneous distribution of PFAS precursors and terminal compounds sorbed to mineral surfaces or associated with organic carbon. The magnitude of solid IDW volumes, coupled with regulatory scrutiny and long-term liability concerns, underscores the need for effective on-site or near-site treatment technologies that address soils directly rather than relying solely on ex-situ liquid-phase polishing.

Conventional approaches used in water treatment—such as adsorption, ion exchange, reverse osmosis, advanced oxidation, or electrochemical processes—are generally configured for aqueous streams and are not directly transferable to bulk solids without pre-extraction. Solid-phase treatments that rely on thermal desorption or incineration can be energy-intensive, pose off-gas management challenges, and risk incomplete PFAS mineralization or undesirable byproducts if process conditions are not tightly controlled. Moreover, logistics and cost constraints frequently render off-site high-temperature treatment impractical for large soil volumes.

Supercritical water oxidation (SCWO) has been identified by environmental regulators as a promising technology for destroying PFAS in aqueous matrices, particularly AFFF concentrates and rinsates. SCWO leverages the unique properties of water above its critical point to achieve rapid oxidation of recalcitrant organics. While laboratory and pilot demonstrations have shown high destruction efficiencies for liquid feeds, the translation of SCWO to PFAS-impacted soils presents distinct engineering and reaction-chemistry challenges that have not been adequately addressed.

Unlike homogeneous liquid feeds, soils present multiphase, heterogenous systems in which PFAS partition among mineral surfaces, pore water, and organic fractions. Mass-transfer limitations, variable moisture content, and heat distribution within solid-liquid slurries complicate reactor design and scale-up. Solids handling introduces risks of plugging and erosion in pressurized systems, and mineral constituents can drive corrosive chemistries at elevated temperature and pressure. These constraints have contributed to a knowledge gap between established SCWO practice for liquids and reliable PFAS destruction in soils.

Reaction media and co-reagents further influence PFAS fate during oxidation. In the absence of appropriate additives, PFAS mineralization can be incomplete, resulting in residual organofluorine species or transient formation of shorter-chain intermediates. Additionally, the formation of hydrofluoric acid under oxidative, high-temperature conditions can exacerbate materials compatibility issues, increase corrosion, and complicate reactor maintenance and uptime.

Alkaline conditions and basic additives can promote defluorination pathways and mitigate acid-driven corrosion. In mixed solid-liquid systems, however, dosing strategies must account for soil buffering capacity, carbonate content, and the reactivity of mineral phases that consume oxidant or neutralize alkalinity. The lack of standardized, soil-focused dosing regimes for oxidants and alkaline additives has limited reproducibility and hindered adoption for PFAS-impacted solids.

Process control and accountability are also critical barriers. Soil treatments require integrated approaches to collect and quantify PFAS mass across all phases—pre- and post-treated solids, condensates, off-gas, and equipment rinsates—to confirm true destruction rather than transfer. Many prior efforts aimed at solids do not include comprehensive mass-balance and defluorination measurements, leaving uncertainty as to mineralization efficiency and the disposition of fluoride.

From an implementation perspective, there is a need to accommodate both batch and continuous reactor modes to match site logistics, throughput, and footprint constraints. Batch reactors can be advantageous for heterogenous soils, discrete lots, or treatability demonstrations, while continuous configurations may be preferred for sustained, higher-throughput operations. Existing disclosures for PFAS treatment in liquids do not provide soil-specific operating windows or hardware configurations that reliably deliver high destruction and defluorination for soil slurries under SCWO or subcritical water oxidation conditions.

In practice, soils at DOD and similar sites may include sands, silts, clays, and mixed lithologies, often requiring slurry preparation to achieve pumpable, well-mixed feeds with controlled solids content. Reactor operating windows that balance temperature, pressure, residence time, oxidant excess, and alkaline additive selection are not well established for these matrices. There remains limited guidance on how to tune these variables to achieve >99% PFAS destruction and high defluorination while maintaining operability and equipment integrity.

There is further a need for bench-to-field protocols that (i) define solids loading ranges appropriate for soil slurries, (ii) specify oxidant sources (e.g., hydrogen peroxide or compressed air) at controlled excess relative to oxygen demand, (iii) identify alkaline additives (e.g., sodium hydroxide or calcium hydroxide) that enhance defluorination and suppress corrosive species, and (iv) integrate condensers and impingers for off-gas cooling and capture to support full PFAS and fluorine mass balance.

Despite increasing attention to PFAS destruction technologies, few viable options currently address PFAS-impacted solid matrices with the combination of high destruction efficiency, high defluorination, solids compatibility, controllable residence times, and integrated mass-balance verification. This gap is acute for large volumes of IDW generated during soil removal actions at PFAS-impacted sites, where interim storage and transport elevate costs and risk.

Accordingly, there is a critical need for systems and methods that directly treat PFAS-impacted soils-preferably as controlled slurries-under SCWO or subcritical water oxidation conditions using defined oxidant and alkaline-additive dosing, that achieve high PFAS destruction and defluorination, manage off-gas via chilled condensation and impingement, and maintain reactor operability with solids.

### SUMMARY OF THE DISCLOSURE

The present disclosure is directed to systems and methods for the destruction of per- and polyfluoroalkyl substances (PFAS) present in soil and other PFAS-impacted solid matrices. In certain embodiments, the systems and methods disclosed herein may be configured to oxidize PFAS contained within soil slurries under controlled temperature and pressure conditions to achieve high degrees of PFAS destruction and defluorination. In particular, aspects of the present disclosure may relate to the use of supercritical water oxidation (SCWO) and subcritical water oxidation processes for PFAS destruction in soil, which may employ defined oxidant and alkaline additive dosing strategies to enhance mineralization efficiency and mitigate corrosion.

To address the need disclosed above, the present disclosure may employ a reactor-based oxidation process in which a soil slurry, containing solids in a range between 20 wt % and 50 wt % and PFAS, is introduced into a sealed reactor vessel together with an oxidant, such as hydrogen peroxide or compressed air, and an alkaline additive, such as sodium hydroxide or calcium hydroxide. The reactor may be pressurized to at least 2,000 pounds per square inch (psi) and heated to a temperature at or above 350° C. The reaction may be maintained under these conditions for a defined period, facilitating oxidative decomposition of PFAS compounds within the soil slurry. In certain embodiments, the systems and methods may be implemented in batch or continuous configurations to accommodate variable treatment volumes and site-specific operational requirements.

The systems of the present disclosure may include a reactor vessel operable to maintain high-temperature and high-pressure conditions suitable for supercritical or subcritical water oxidation, an oxidant delivery assembly that may be configured to dose hydrogen peroxide or compressed air, and an additive delivery assembly that may be configured to introduce alkaline reagents. The system may further include a pressurization assembly that may be configured to regulate reactor pressure, a heating assembly that may be configured to control reactor temperature, and a venting assembly that may direct off-gas through a chilled condenser and methanol impinger for capture and quantification of mineralized products. In certain embodiments, these components may be integrated to enable accurate PFAS and fluorine mass balance across solid, liquid, and gaseous phases.

The systems and methods disclosed herein may provide numerous advantages over existing approaches for PFAS treatment in soils. By utilizing controlled supercritical or subcritical water oxidation conditions, the disclosed technology may achieve PFAS destruction efficiencies exceeding 99%, and in some embodiments greater than 99.8%, with corresponding high levels of defluorination. The combination of oxidant dosing and alkaline additives may promote complete mineralization of PFAS compounds while minimizing the formation of corrosive species such as hydrofluoric acid. Moreover, the use of slurried soils may improve mass transfer and reaction homogeneity, allowing for consistent treatment of heterogeneous soil matrices.

The disclosed systems may further enable accurate mass-balance verification through integrated sampling of treated solids, condensates, off-gas, and rinsates, ensuring that destruction is confirmed rather than merely transfer. By incorporating both batch and continuous reactor configurations, the disclosed technology may be adaptable to laboratory-scale testing, field treatability studies, and full-scale remediation applications. Additionally, the approach may reduce reliance on high-energy incineration, avoid generation of secondary waste streams, and eliminate the need for costly off-site disposal or thermal desorption operations.

Accordingly, the present disclosure may provide a scalable, efficient, and environmentally responsible solution for addressing the persistent challenge of PFAS contamination in soils. By enabling treatment of PFAS-impacted solids under controlled oxidative conditions, the disclosed systems and methods may advance the state of PFAS remediation and fill a critical gap in current soil treatment technologies.

In general, in one embodiment, the disclosure features a method for the destruction of per- and polyfluoroalkyl substances (PFAS) in soil. The method can include providing a soil composition including PFAS. The method can include introducing the soil composition into a sealed reactor vessel. The method can include introducing into the reactor vessel an oxidant selected from the group consisting of hydrogen peroxide and compressed air. The method can include dosing the soil composition with the oxidant, where the dosing results in formation of a dosed soil composition. The method can include introducing into the reactor vessel an alkaline additive selected from the group consisting of sodium hydroxide and calcium hydroxide. The method can include pressurizing the reactor vessel to a reactor pressure at or above 2,000 psi. The method can include heating the reactor vessel to a reactor temperature at or above 350° C. The method can further include maintaining the dosed soil composition and the alkaline additive at the reactor pressure and the reactor temperature for a reaction period, where more than 90 wt % [RSG1] of the PFAS present in the dosed soil composition are destructed.

Implementations of the disclosure can include one or more of the following features:

The reactor pressure can be in a pressure range between approximately 2,000 psi and approximately 4,000 psi.

The reactor temperature can be in a temperature range between approximately 350° C. and approximately 500° C.

The reaction period can be in a period range between approximately 0.5 hours and approximately 2 hours.

The oxidant can include hydrogen peroxide having a concentration in a range between approximately 40 wt % and approximately 60 wt % in aqueous solution.

The oxidant can include compressed air.

The compressed air can be supplied from a high-pressure cylinder regulated to the reactor vessel.

The alkaline additive can include sodium hydroxide.

The alkaline additive can include calcium hydroxide.

The soil composition can include soil selected from the group consisting of clay, sand, silt, loam, and combinations thereof.

The dosed soil composition can be a soil slurry that includes between 25 wt % and 45 wt % solids.

After maintaining the dosed soil composition and the alkaline additive at the reactor pressure and the reactor temperature for the reaction period, the method can further include releasing pressure to release off-gas and utilizing a chilled condenser to cool the off-gas.

The method can further include passing the off-gas cooled by the chilled condenser through a methanol impinger, which acts as a sink for volatiles coming out of the reactor vessel.

The chilled condenser can contain chilled methanol at a temperature below room temperature.

Maintaining the dosed soil composition and the alkaline additive at the reactor pressure and the reactor temperature for a reaction period can destruct more than 99 wt % of the PFAS present in the dosed soil composition.

Maintaining the dosed soil composition and the alkaline additive at the reactor pressure and the reactor temperature for a reaction period can destruct more than 99.8 wt % of the PFAS present in the dosed soil composition.

The reactor temperature can be at or above a supercritical temperature.

The reactor pressure can be at or above a supercritical pressure.

In general, in another embodiment, the disclosure features a system for the destruction of per- and polyfluoroalkyl substances (PFAS) in soil. The system can include a sealed reactor vessel configured to contain a soil composition including PFAS. The system can include an oxidant delivery assembly configured to introduce into the reactor vessel an oxidant selected from the group consisting of hydrogen peroxide and compressed air. The system can include an additive delivery assembly configured to introduce into the reactor vessel an alkaline additive selected from the group consisting of sodium hydroxide and calcium hydroxide. The system can include a pressurization assembly including a pressurization valve and a pressure gauge, where the pressurization assembly is configured to pressurize the reactor vessel to a reactor pressure at or above 2,000 psi. The system can include a heating assembly configured to heat the reactor vessel to a reactor temperature at or above 350° C. The system can include a thermocouple assembly configured to monitor temperature inside the reactor vessel. The system can include a venting assembly including a vent valve connected to the reactor vessel. The sealed reactor can be configured to maintain the soil composition, the oxidant, and the alkaline additive under the reactor pressure and the reactor temperature for a reaction period. The sealed reactor can also be configured to destroy more than 90 wt % of the PFAS present in the soil composition.

Implementations of the disclosure can further include one or more of the following system features:

The reactor vessel can be operable to be pressurized to the reactor pressure in the range between approximately 2,000 psi and approximately 4,000 psi.

The heating assembly can be operable to be heated to the reactor temperature, where the reactor temperature is in the range between approximately 400° C. and approximately 500° C.

The oxidant delivery assembly can include a supply line connected to a hydrogen peroxide source having a concentration in the range between approximately 40 wt % and approximately 60 wt % in aqueous solution.

The oxidant delivery assembly can include a supply line connected to a compressed air cylinder.

The compressed air cylinder can be a high-pressure cylinder coupled with a regulator for delivering compressed air to the reactor vessel.

The additive delivery assembly can be configured to deliver sodium hydroxide to the reactor vessel.

The additive delivery assembly can be configured to deliver calcium hydroxide to the reactor vessel.

The pressurization assembly and the heating assembly can be jointly configured to maintain the reactor vessel at the reactor temperature and the reactor pressure for a reaction period in the range between approximately 0.5 hours and approximately 2 hours.

The sealed reactor vessel can be configured to contain the soil composition including soil selected from the group consisting of clay, sand, silt, loam, and combinations thereof.

The dosed soil composition can be a soil slurry that includes between 25 wt % and 45 wt % solids.

The system can further include a condenser connected to the venting assembly, where the condenser is operable for condensing off-gas released from the reactor through the venting assembly.

The system can further include a methanol impinger, where the methanol impinger is operable to pass the off-gas cooled by the chilled condenser therethrough and act as a sink for volatiles coming out of the reactor vessel.

The chilled condenser can contain chilled methanol at a temperature below room temperature.

The sealed reactor can be configured to destroy more than 99 wt % of the PFAS present in the soil composition.

The sealed reactor can be configured to destroy more than 99.8 wt % of the PFAS present in the soil composition.

The reactor temperature can be at or above a supercritical temperature.

The reactor pressure can be at or above a supercritical pressure.

### BRIEF DESCRIPTION OF THE DRAWINGS

Other advantages of the present disclosure will be apparent from the following detailed description of the disclosure in conjunction with embodiments as illustrated in the accompanying drawings, in which:

FIG. 1 depicts a schematic diagram of a system for the destruction of PFAS in soil, in accordance with certain embodiments of the present disclosure.

FIG. 2 depicts graphical results of PFAS destruction in spiked soil testing, showing percent PFAS destruction, total PFAS concentration prior to treatment, and total PFAS concentration in post-treated soil, in accordance with certain embodiments of the present disclosure.

FIG. 3 depicts PFAS mass-balance results for field soils, including percent PFAS destruction, percent mass balance, and percent defluorination under both subcritical water oxidation and supercritical water oxidation conditions, in accordance with certain embodiments of the present disclosure.

### NOTATION AND NOMENCLATURE

Various terms are used to refer to particular system components. Different companies may refer to a component by different names—this document does not intend to distinguish between components that differ in name but not function. In the following discussion and in the claims, the terms “including” and “comprising” are used in an open-ended fashion, and thus should be interpreted to mean “including, but not limited to” Also, the term “couple” or “couples” is intended to mean either an indirect or a direct connection. Thus, if a first device couples to a second device, that connection may be through a direct connection or through an indirect connection via other devices and connections.

The terminology used herein is for the purpose of describing particular example embodiments only, and is not intended to be limiting. Following long-standing patent law convention, the terms “a” and “an” mean “one or more” when used in this application, including the claims.

As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer, or section from another region, layer, or section. Terms such as “first,” “second,” and other numerical terms, when used herein, do not imply a sequence or order unless clearly indicated by the context. Thus, a first element, component, region, layer, or section discussed below could be termed a second element, component, region, layer, or section without departing from the teachings of the example embodiments. The phrase “at least one of,” when used with a list of items, means that different combinations of one or more of the listed items may be used, and only one item in the list may be needed. As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D. Accordingly, as an example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Spatially relative terms, such as “inner,” “outer,” “beneath,” “below,” “lower,” “above,” “upper,” “top,” “bottom,” and the like, may be used herein. These spatially relative terms can be used for ease of description to describe one element's or feature's relationship to another element(s) or feature(s) as illustrated in the figures. The spatially relative terms may also be intended to encompass different orientations of the device in use, or operation, in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

Unless otherwise indicated, all numbers expressing quantities of ingredients, reaction conditions, and so forth used in the specification are to be understood as being modified in all instances by the term “about.” Accordingly, unless indicated to the contrary, the numerical parameters set forth in this specification are approximations that can vary depending upon the desired properties sought to be obtained by the presently disclosed subject matter.

### DETAILED DESCRIPTION OF THE DISCLOSURE

The present disclosure is directed to systems and methods for the destruction of per- and polyfluoroalkyl substances (PFAS) in soil and other PFAS-impacted solid matrices. In certain embodiments, the systems and methods disclosed herein can be configured to oxidize PFAS contained within soil slurries under controlled temperature and pressure conditions to achieve high degrees of PFAS destruction and defluorination. In particular, aspects of the present disclosure relate to the use of supercritical water oxidation (SCWO) and subcritical water oxidation processes for PFAS destruction in soil, using defined oxidant and alkaline additive dosing strategies to enhance mineralization efficiency and mitigate corrosion.

The disclosure provides sustainable systems, devices, and methods for the treatment of PFAS-impacted soils that address the limitations of prior art, which include low destruction efficiencies, incomplete defluorination, and high energy demands. The systems and methods disclosed herein offer a novel approach for the destruction of PFAS in solid matrices by employing controlled reactor-based oxidation, adaptable to both batch and continuous operation modes. Through the combination of oxidant dosing, alkaline additives, and elevated reaction conditions, these embodiments can achieve greater than 90%, and in some cases greater than 99.8%, PFAS destruction while maintaining reactor integrity and minimizing secondary waste generation.

In some embodiments, the disclosed systems can be implemented at laboratory, pilot, or field scale to treat PFAS-contaminated soils generated as investigation-derived waste (IDW) from remediation activities, including those associated with Department of Defense sites and other PFAS-impacted locations. The approach enables direct treatment of soils or soil slurries without reliance on off-site incineration or disposal, thereby offering a scalable, cost-effective, and environmentally responsible solution for PFAS management.

The systems and methods of the present disclosure can include the use of oxidants such as hydrogen peroxide or compressed air and alkaline additives such as sodium hydroxide or calcium hydroxide. By operating under reactor pressures at or above 2,000 psi and reactor temperatures at or above 350° C., the disclosed systems facilitate rapid oxidative decomposition of PFAS compounds within the soil matrix. In some embodiments, reaction conditions can be maintained within the supercritical region to promote complete mineralization of PFAS and maximize fluorine recovery.

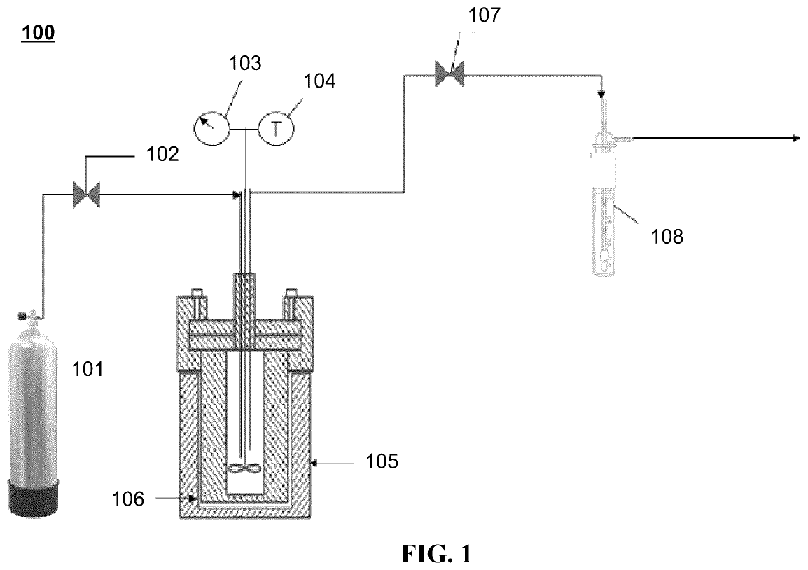

FIG. 1 depicts a schematic diagram of a system 100 for the destruction of per- and polyfluoroalkyl substances (PFAS) in soil, in accordance with certain embodiments of the present disclosure. The system 100 can include a nitrogen gas cylinder 101 operable to purge air from the reactor and provide an initial gas cap pressure. A pressurization valve 102 and a pressure gauge 103 can be coupled to the nitrogen source (nitrogen gas cylinder 101) to regulate and monitor internal reactor pressure. The reactor vessel 106 of the system 100 can be equipped with an internal thermocouple reader 104 for temperature monitoring and an electrical heating coil 105 configured to maintain a uniform reaction temperature. The system 100 can further include a vent valve 107 to enable controlled release of gaseous products, which can be directed through a deionized-water impinger 108 that acts as a sink for volatiles and condensable species evolved during reactor depressurization and cooling.

For example, in one working embodiment, the system 100 can utilize a Parr high-temperature and high-pressure reactor vessel. As shown in the working embodiment discussed below, the reactor vessel may be 0.5 liters. In other embodiments, the size of the reactor vessel may be larger, such as for example, 1 liter, 10 liter, 100 liter. The reactor vessel can include a stainless-steel body with a needle valve, pressure gauge, rupture disk, graphite gasket, and thermowell with thermocouple. The reactor vessel can operate at pressures up to approximately 5,000 psi and temperatures up to approximately 500° C.

Prior to each utilization of the system, nitrogen gas cylinder 101 can be used to purge residual air and establish an initial headspace pressure suitable for achieving the desired operating pressure, such as 3,500 psi. Heating coil 105 can be energized to reach the target temperature, while thermocouple reader 104 provides real-time temperature monitoring.

During operation, a pre-measured quantity of PFAS contaminated soil (spiked or field soil) can be introduced into reactor vessel 106 following oxidant dosing. The contaminated soil can have a soil composition including soil containing clay, sand, silt, loam, and combinations thereof. Oxidant dosing of the PFAS contaminated soil can occur before, during, or after introduction into reactor vessel 106.

For example, in some embodiments, hydrogen peroxide (50 wt % aqueous solution) can be employed as the oxidant source, at approximately 200% excess oxygen relative to the stoichiometric oxygen demand of the feed, as determined by the carbon-oxygen demand of the PFAS contaminated soil. The excess oxygen fraction can be calculated according to:

$${O}_{2 , excess} = \frac{{[ {O}_{2} ]}_{actual}}{{[ {O}_{2} ]}_{stoich}} * 100$$

In the equation above, [O₂]_{actual} is the concentration of O₂ released from the decomposition of hydrogen peroxide introduced into the reactor at the start of the reaction (mg/L), and [O₂]_{stoich} is the stoichiometric required concentration of O₂ to obtain complete oxidation of the feed based on chemical oxygen demand of the feed.

Further, in some embodiments, compressed air from a high-pressure regulated cylinder can serve as the oxidant source, introduced at 200% excess oxygen and 3,500 psi to match prior conditions and reduce process variability.

The determination can include recording the soil mass and adding it to reactor vessel 106 after oxidant dosing. In some embodiments, the soil mass can be approximately 100 g. The reactor head of the reactor vessel 106 can be secured with a flexible graphite gasket and torqued to manufacturer specification (for example, 40 ft-lb).

Thermocouple connections can be made, and heating initiated until the target temperature is reached. In some embodiments, the target temperature can be 350° C. for subcritical water oxidation. In other embodiments, the target temperature can be 420-450° C. for supercritical water oxidation.

Reactor pressure can be maintained at the desired setpoint (such as for example, but not limited to, 3,500 psi) throughout the reaction period. The reaction period, in some embodiments, may range between approximately 0.5 to 1 hour.

After completion of the designated holding time, heating can be discontinued, and the vessel slowly depressurized by venting through impinger 108 containing deionized water.

After cooling below approximately 40° C., the assembly can be disassembled, and the treated soil recovered, weighed, and sampled for PFAS analysis. The reactor head and vessel can be rinsed multiple times with HPLC-grade methanol, with rinsates collected in polypropylene centrifuge tubes and stored at 4° C.-6° C. If needed, rinsate can be concentrated under a gentle nitrogen stream and reconstituted in methanol prior to testing.

In some embodiments, sodium hydroxide (NaOH) and calcium hydroxide (Ca(OH)₂) (alkaline additives) can be introduced with PFAS-contaminated soils to evaluate effects on PFAS destruction and defluorination. Calcium hydroxide can promote hydro-defluorination via conversion of carbon-fluorine bonds to carbon-hydrogen bonds, potentially enhancing mineralization.

The system 100 can enable controlled oxidation of PFAS in soils under subcritical conditions (for example, but not limited to, 350° C., 2,000 psi) and supercritical conditions (for example, but not limited to, 420° C.-450° C., 3,500 psi). As discussed below, the configurations have been utilized to facilitate PFAS destruction efficiencies greater than 99%, with supercritical operation generally yielding improved defluorination relative to subcritical operation.

PFAS-Spiked Ottawa Sand and Calcium Oxide

In certain embodiments, PFAS destruction can be evaluated using Ottawa sand spiked to 10 ppm total PFAS (e.g., PFOA and PFOS at a combined 10 μg/g). Prior to spiking, the PFAS stock solution can be sonicated for 10 minutes. The spiked sand can be dosed with hydrogen peroxide at excess oxygen relative to the sample carbon-oxygen demand (COD), typically 200% for field soils and 100-200% for laboratory spiked Ottawa sand, and combined with calcium oxide. Samples can be heated in a sealed metal reactor capable of up to 500° C. operation, with off-gas directed through a condenser and a methanol impinger. Representative stoichiometry and a test matrix suitable for optimization are shown in TABLE I and TABLE II.

TABLE I
Stoichiometric Mass for H₂O₂ and CaO (100 g sand)

| | | | | | | | Total Grams | | |
|---|---|---|---|---|---|---|---|---|---|
| Sand | PFOS | | Required Mole | | Required Gram | | Required | | 50 wt % |
| gram | gram | mole | H₂O₂ | CaO | H₂O₂ | CaO | H₂O₂ (g) | CaO (g) | H₂O₂ (g) |
| 100 | 5E−04 | 9.9974E−07 | 1.74955E−05 | 1.74955E−05 | 0.000595 | 0.000981 | 0.001191 | 0.0020308 | 0.002381 |
| Sand | PFOA | | Required Mole | | Required Gram | | | | |
| gram | gram | mole | H₂O₂ | CaO | H₂O₂ | CaO | | | |
| 100 | 5E−04 | 1.2075E−06 | 1.75091E−05 | 1.87166E−05 | 0.000595 | 0.00105 | | | |

TABLE II
Reactor Conditions for Optimization on Spiked Sand and Field Soil

| | Pressure | Temperature | Duration | CaO/NaOH | |
|---|---|---|---|---|---|
| Test | (psi) | (° C.) | (hour) | Addition | Analyses |
| Spiked Soil (sub-SCWO) | 2000 | 350 | 0.5 | CaO | Soil, Aqueous |
| Spiked Soil (sub-SCWO) | 2000 | 350 | 1 | CaO | filtrate, Equipment |
| Spiked Soil (sub-SCWO) | 2000 | 350 | 1 | NaOH | Rinsate Parameters: |
| Spiked Soil (SCWO) | 3500 | 420 | 0.5 | CaO | 24 PFAS |
| Spiked Soil (SCWO) | 3500 | 420 | 1 | CaO | |
| Spiked Soil (SCWO) | 3500 | 420 | 1 | NaOH | |
| Field Soil (sub-SCWO) | 2000 | 350 | 1 | CaO | |
| Field Soil (SCWO) | 3500 | 420 | 1 | CaO | |

Reactor setup can include a 0.5-liter Parr autoclave reactor with stainless-steel vessel, needle valve, pressure gauge, rupture disk, graphite gasket, and thermowell with thermocouple. The system can be purged and pressurized using nitrogen to establish an initial headspace and to facilitate controlled venting. Heating can be provided by an external mantle or coil. Following the reaction period, off-gas can be routed through a chilled condenser and then through a methanol impinger to capture volatiles for analysis.

### Evaluation of Alkaline Additives (NaOH and Ca(OH)₂)

In certain embodiments, the effect of alkaline additives on PFAS destruction can be assessed by introducing measured quantities of sodium hydroxide or calcium hydroxide to the spiked soil slurry. Calcium hydroxide can promote hydro-defluorination, and sodium hydroxide can neutralize potential hydrofluoric acid formation. Conditions identified during optimization (pressure, temperature, and holding time) can be applied to compare PFAS destruction and defluorination performance between the additives.

### Field-Derived Soil at Optimized Conditions

In certain embodiments, a field soil previously impacted by aqueous film-forming foam can be sieved to less than 2 mm, homogenized, and treated using the optimized oxidation conditions determined on the spiked Ottawa sand. Representative subcritical and supercritical runs can be performed at 350° C. and 2000 psi, and at 420° C.-450° C. and 3500 psi, respectively, with calcium oxide or calcium hydroxide as alkaline additive. Post-treatment solids, equipment rinsates, condensates, and impinger solutions can be collected for targeted PFAS and fluorine analyses.

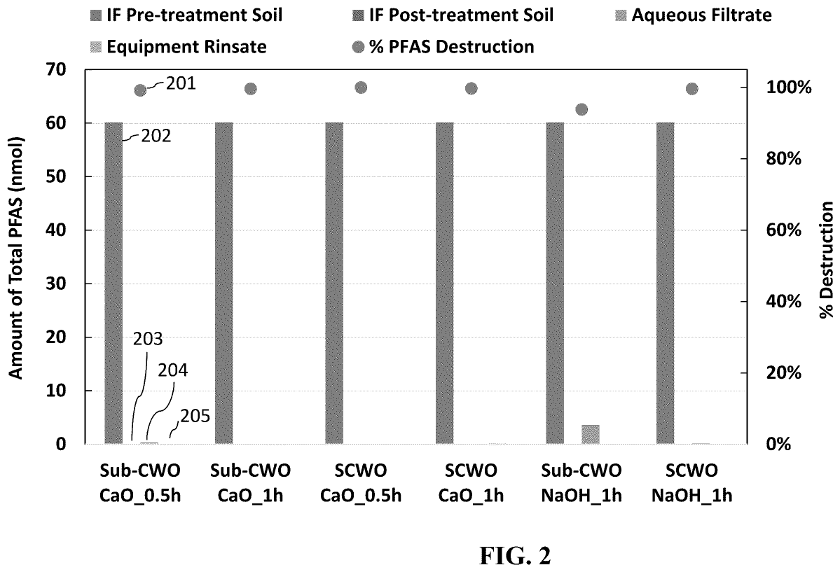

FIG. 2 presents representative results from the spiked-soil oxidation runs conducted under both subcritical and supercritical conditions. As shown in FIG. 2, percent PFAS destruction 201 is plotted alongside total PFAS content (nmol) prior to treatment 202 and total PFAS content (nmol) in post-treated soils 203. (FIG. 2 also shows the aqueous filtrate 204 and equipment rinsate 205).

In these embodiments, PFAS-spiked Ottawa sand samples initially contained approximately 10 μg/g total PFAS, primarily PFOA and PFOS. Following treatment under optimized conditions, supercritical water oxidation (SCWO) yielded destruction efficiencies exceeding 99%, reducing residual PFAS concentrations to near or below the analytical detection limit. Subcritical water oxidation (sub-SCWO) conditions (for example, but not limited to, 350° C., 2,000 psi) also achieved high destruction, typically in the range of 93%-98%, depending on the additive formulation. The observed reduction in PFAS concentration demonstrates that oxidative mineralization under the tested conditions is sufficient to achieve near-complete decomposition of targeted perfluoroalkyl compounds within a single reaction cycle.

The data shown in FIG. 2 further illustrate the comparative performance of sodium hydroxide and calcium-based additives. Runs performed with calcium oxide or calcium hydroxide under subcritical conditions exhibited enhanced PFAS removal relative to sodium hydroxide. This improvement may be attributed to the dual role of calcium reagents, which not only increase solution alkalinity but also promote defluorination via hydro-defluorination reactions that convert carbon-fluorine bonds to carbon-hydrogen bonds. Conversely, sodium hydroxide primarily serves as a base neutralizer, mitigating hydrofluoric acid formation but providing less direct fluorine capture. The high reproducibility across replicate tests indicates that both additive systems are chemically compatible with hydrogen peroxide or compressed-air oxidants under the specified temperature-pressure regimes.

### PFAS and Fluorine Mass Balance

In certain embodiments, a mass balance can be established by quantifying PFAS and fluorine across solid, liquid, and gas-phase capture media.

### PFAS Mass Balance:

$$PFAS in {Soil}_{before treatment} = PFAS in {Soil}_{after treatment} + PFAS in {Methanol}_{Impinger} + PFAS in Equipment Rinsate$$

### Fluorine Mass Balance:

$$F in {Soil}_{before treatment} = F in {Soil}_{after treatment} + F in {Methanol}_{Impinger} + F in Equipment Rinsate$$

Pre- and post-treatment soils can be analyzed by LC-MS/MS for targeted PFAS and by extractable total organofluorine or combustion-IC for fluorine. Condensed phases from the chilled condenser and methanol impinger can be analyzed similarly. Rinsates from reactor and transfer lines can be included to close the material balance.

Results can be summarized against three primary metrics: percent PFAS destruction, percent mass balance closure, and percent defluorination.

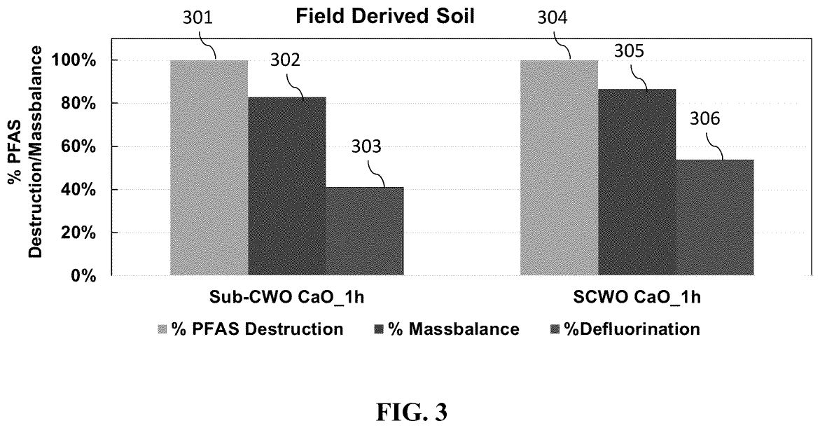

FIG. 3 presents field-soil oxidation and mass-balance outcomes under both subcritical and supercritical regimes. Under subcritical conditions (350° C., 2,000 psi), the percent PFAS destruction 301 exceeded 90%, with mass-balance closure 302 generally within 85-105%, confirming comprehensive accounting across the solid, liquid, and gas phases. The corresponding percent defluorination 303, while significant, remained lower than under supercritical operation, consistent with the lower energy state of the subcritical water medium and reduced formation of reactive radicals.

Under supercritical conditions (420-450° C., 3,500 psi), as reflected by percent PFAS destruction 304, mass-balance closure 305, and percent defluorination 306, destruction efficiencies consistently exceeded 99%, and in some cases 99.8%, with residual PFAS in the post-treated soil matrix below method detection limits. Fluorine release was correspondingly higher, indicating more complete cleavage of carbon-fluorine bonds and enhanced mineralization. The mass-balance closure under these conditions remained within the analytical uncertainty, demonstrating that the combined sampling of treated solids, condensate, and off-gas captures the fate of fluorinated species and supports the assertion of chemical destruction rather than physical transfer.

Across all batch-scale tests, no measurable PFAS carryover or formation of volatile fluorinated intermediates was detected in the methanol impinger solutions, further validating oxidative completeness. Moreover, defluorination trends aligned with increasing temperature and pressure, suggesting that reactive radical formation and water density at supercritical conditions favor complete C—F bond scission. Collectively, the results shown in FIGS. 2-3 demonstrate that both subcritical and supercritical water oxidation pathways are effective for PFAS destruction in solid matrices, with the latter providing superior mineralization efficiency and fluorine recovery.

In certain embodiments, these findings support the use of the disclosed systems and methods for site-specific treatment of PFAS-impacted soils and sludges, enabling in-situ or near-site remediation under controlled oxidative conditions. The demonstrated high levels of PFAS destruction and defluorination achieved in these working examples confirm that both the subcritical and supercritical modes can be deployed depending on site constraints, energy availability, and additive selection, while achieving environmentally responsible outcomes and minimizing secondary waste generation

In certain embodiments, as shown in the working examples, reactor background and decontamination checks can confirm that high-temperature operation does not introduce PFAS background contamination and that the cleaning protocol prevents cross-test carryover. Between runs, the reactor can be cleaned with sequential acid, water, base, water, high-purity water, and methanol rinses, as appropriate for PFAS-free handling.

In certain embodiments, hydrogen peroxide can be used as an oxidant at a defined oxygen-excess fraction. In further embodiments, compressed air can be used at 200% excess oxygen and an operating pressure of 3500 psi to provide parity with peroxide-based testing.

The foregoing description, for purposes of explanation, used specific nomenclature to provide a thorough understanding of the described embodiments. However, it should be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

While embodiments of the disclosure have been shown and described, modifications thereof can be made by one skilled in the art without departing from the spirit and teachings of the disclosure. The embodiments described and the examples provided herein are exemplary only, and are not intended to be limiting. Many variations and modifications of the disclosure disclosed herein are possible and are within the scope of the disclosure. The scope of protection is not limited by the description set out above, but is only limited by the claims which follow, that scope including all equivalents of the subject matter of the claims.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described. The symbol “˜” is the same as “approximately”.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

Those skilled in the art will appreciate that the steps described herein may be carried out in a variety ways and that no particular ordering is required. It will be further understood from the foregoing description that modifications and changes may be made in various embodiments of the present disclosure without departing from its true spirit. The descriptions in this specification are for purposes of illustration only and are not to be construed in a limiting sense.

Consistent with the above disclosure, the examples of systems and methods enumerated in the following clauses are specifically contemplated and are intended as a non-limiting set of examples.
Clause 1. A method for the destruction of per- and polyfluoroalkyl substances (PFAS) in soil, the method including providing a soil composition including PFAS; introducing the soil composition into a sealed reactor vessel; introducing into the reactor vessel an oxidant selected from the group consisting of hydrogen peroxide and compressed air; dosing the soil composition with the oxidant, where the dosing results in formation of a dosed soil composition; introducing into the reactor vessel an alkaline additive selected from the group consisting of sodium hydroxide and calcium hydroxide; pressurizing the reactor vessel to a reactor pressure at or above 2000 psi; heating the reactor vessel to a reactor temperature at or above 350° C.; and maintaining the dosed soil composition and the alkaline additive at the reactor pressure and the reactor temperature for a reaction period, where more than 90 wt % of the PFAS present in the dosed soil composition are destructed.
Clause 2. The method of any foregoing method, where the reactor pressure is in a pressure range between approximately 2,000 psi and approximately 4,000 psi.
Clause 3. The method of any foregoing method, where the reactor temperature is in a temperature range between approximately 350° C. and approximately 500° C.
Clause 4. The method of any foregoing method, where the reaction period is in a period range between approximately 0.5 hours and approximately 2 hours.
Clause 5. The method of any foregoing method, where the oxidant includes hydrogen peroxide having a concentration in a range between approximately 40 wt % and approximately 60 wt % in aqueous solution.
Clause 6. The method of any foregoing method, where the oxidant includes compressed air.
Clause 7. The method of any foregoing method, where the compressed air is supplied from a high-pressure cylinder regulated to the reactor vessel.
Clause 8. The method of any foregoing method, where the alkaline additive includes sodium hydroxide.
Clause 9. The method of any foregoing method, where the alkaline additive includes calcium hydroxide.
Clause 10. The method of any foregoing method, where the soil composition includes soil selected from the group consisting of clay, sand, silt, loam, and combinations thereof.
Clause 11. The method of any foregoing method, where the dosed soil composition is a soil slurry that includes between 25 wt % and 45 wt % solids.
Clause 12. The method of any foregoing method, where, after maintaining the dosed soil composition and the alkaline additive at the reactor pressure and the reactor temperature for the reaction period, the method further includes releasing pressure to release off-gas and utilizing a chilled condenser to cool the off-gas.
Clause 13. The method of any foregoing method, where the method further includes passing the off-gas cooled by the chilled condenser through a methanol impinger, which acts as a sink for volatiles coming out of the reactor vessel.
Clause 14. The method of any foregoing method, where the chilled condenser contains chilled methanol at a temperature below room temperature.
Clause 15. The method of any foregoing method, where maintaining the dosed soil composition and the alkaline additive at the reactor pressure and the reactor temperature for a reaction period destructs more than 99 wt % of the PFAS present in the dosed soil composition.
Clause 16. The method of any foregoing method, where maintaining the dosed soil composition and the alkaline additive at the reactor pressure and the reactor temperature for a reaction period destructs more than 99.8 wt % of the PFAS present in the dosed soil composition.
Clause 17. The method of any foregoing method, where the reactor temperature is at or above a supercritical temperature.
Clause 18. The method of any foregoing method, where the reactor pressure is at or above a supercritical pressure.
Clause 19. A system for the destruction of per- and polyfluoroalkyl substances (PFAS) in soil, the system including a sealed reactor vessel configured to contain a soil composition including PFAS; an oxidant delivery assembly configured to introduce into the reactor vessel an oxidant, where the oxidant is selected from the group consisting of hydrogen peroxide and compressed air; an additive delivery assembly configured to introduce into the reactor vessel an alkaline additive, where the alkaline additive is selected from the group consisting of sodium hydroxide and calcium hydroxide; a pressurization assembly including a pressurization valve and a pressure gauge, where the pressurization assembly is configured to pressurize the reactor vessel to a reactor pressure at or above 2000 psi; a heating assembly configured to heat the reactor vessel to a reactor temperature at or above 350° C.; a thermocouple assembly configured to monitor temperature inside the reactor vessel; and a venting assembly including a vent valve connected to the reactor vessel, where the sealed reactor is configured to maintain the soil composition, the oxidant, and the alkaline additive under the reactor pressure and the reactor temperature for a reaction period, and where the sealed reactor is configured to destroy more than 90 wt % of the PFAS present in the soil composition.
Clause 20. The system of any foregoing system, where the reactor vessel is operable to be pressurized to the reactor pressure in the range between approximately 2,000 psi and approximately 4,000 psi.
Clause 21. The system of any foregoing system, where the heating assembly is operable to be heated to the reactor temperature, where the reactor temperature is in the range between approximately 400° C. and approximately 500° C.
Clause 22. The system of any foregoing system, where the oxidant delivery assembly includes a supply line connected to a hydrogen peroxide source having a concentration in the range between approximately 40 wt % and approximately 60 wt % in aqueous solution.
Clause 23. The system of any foregoing system, where the oxidant delivery assembly includes a supply line connected to a compressed air cylinder.
Clause 24. The system of any foregoing system, where the compressed air cylinder is a high-pressure cylinder coupled with a regulator for delivering compressed air to the reactor vessel.
Clause 25. The system of any foregoing system, where the additive delivery assembly is configured to deliver sodium hydroxide to the reactor vessel.
Clause 26. The system of any foregoing system, where the additive delivery assembly is configured to deliver calcium hydroxide to the reactor vessel.
Clause 27. The system of any foregoing system, where the pressurization assembly and the heating assembly are jointly configured to maintain the reactor vessel at the reactor temperature and the reactor pressure for a reaction period in the range between approximately 0.5 hours and approximately 2 hours.
Clause 28. The system of any foregoing system, where the sealed reactor vessel is configured to contain the soil composition including soil selected from the group consisting of clay, sand, silt, loam, and combinations thereof.
Clause 29. The system of any foregoing system, where the dosed soil composition is a soil slurry that includes between 25 wt % and 45 wt % solids.
Clause 30. The system of any foregoing system further including a condenser connected to the venting assembly, where the condenser is operable for condensing off-gas released from the reactor through the venting assembly.
Clause 31. The system of any foregoing system further including a methanol impinger, where the methanol impinger is operable to pass the off-gas cooled by the chilled condenser therethrough and act as a sink for volatiles coming out of the reactor vessel.
Clause 32. The system of any foregoing system, where the chilled condenser contains chilled methanol at a temperature below room temperature.
Clause 33. The system of any foregoing system, where the sealed reactor is configured to destroy more than 99 wt % of the PFAS present in the soil composition.
Clause 34. The system of any foregoing system, where the sealed reactor is configured to destroy more than 99.8 wt % of the PFAS present in the soil composition.
Clause 35. The system of any foregoing system, where the reactor temperature is at or above a supercritical temperature.
Clause 36. The system of any foregoing system, where the reactor pressure is at or above a supercritical pressure.

### REFERENCES

Krause, M., J., E. Thoma, E. Sahle-Damesessie, B. Crone, A. Whitehill, E. Shields and B. Gullett (2022). “Supercritical water oxidation as an innovative technology for pfas destruction.” Journal of Environmental Engineering 148 (2): 05021006.
Pinkard, B. R., S. Shetty, D. Stritzinger, C. Bellona and I. V. Novosselov (2021). “Destruction of perfluorooctanesulfonate (pfos) in a batch supercritical water oxidation reactor.” Chemosphere 279:130834.
U.S. EPA (Environmental Protection Agency). (2020). Interim guidance for public comment. Planned Research and Development on Destruction and Disposal Technologies for PFAS and PFAS-Containing Materials.
Wang, Fei, Xingwen Lu, Kaimin Shih, and Chengshuai Liu. (2011). “Influence of calcium hydroxide on the fate of perfluorooctanesulfonate under thermal conditions,” Journal of Hazardous Materials, 192:1067-71.

What is claimed is:

1. A method for the destruction of per- and polyfluoroalkyl substances (PFAS) in soil, the method comprising:
(a) providing a soil composition comprising PFAS;
(b) introducing the soil composition into a sealed reactor vessel;
(c) introducing into the reactor vessel an oxidant selected from the group consisting of hydrogen peroxide and compressed air;
(d) dosing the soil composition with the oxidant, wherein the dosing results in formation of a dosed soil composition;
(e) introducing into the reactor vessel an alkaline additive selected from the group consisting of sodium hydroxide and calcium hydroxide;
(f) pressurizing the reactor vessel to a reactor pressure at or above 2000 psi;
(g) heating the reactor vessel to a reactor temperature at or above 350° C.; and
(h) maintaining the dosed soil composition and the alkaline additive at the reactor pressure and the reactor temperature for a reaction period, wherein more than 90 wt % of the PFAS present in the dosed soil composition are destructed.

2. The method of claim 1, wherein the reactor pressure is in a pressure range between approximately 2,000 psi and approximately 4,000 psi.

3. The method of claim 1, wherein the reactor temperature is in a temperature range between approximately 350° C. and approximately 500° C.

4. The method of claim 1, wherein the reaction period is in a period range between approximately 0.5 hours and approximately 2 hours.

5. The method of claim 1, wherein the oxidant comprises hydrogen peroxide having a concentration in a range between approximately 40 wt % and approximately 60 wt % in aqueous solution.

6. The method of claim 1, wherein the oxidant comprises compressed air.

7. The method of claim 6, wherein the compressed air is supplied from a high-pressure cylinder regulated to the reactor vessel.

8. The method of claim 1, wherein the alkaline additive comprises sodium hydroxide.

9. The method of claim 1, wherein the alkaline additive comprises calcium hydroxide.

10. The method of claim 1, wherein the soil composition comprises soil selected from the group consisting of clay, sand, silt, loam, and combinations thereof.

11. The method of claim 1, wherein the dosed soil composition is a soil slurry that comprises between 25 wt % and 45 wt % solids.

12. The method of claim 1, wherein, after maintaining the dosed soil composition and the alkaline additive at the reactor pressure and the reactor temperature for the reaction period, the method further comprises
(a) releasing pressure to release off-gas; and
(b) utilizing a chilled condenser to cool the off-gas.

13. The method of claim 12, wherein the method further comprises passing the off-gas cooled by the chilled condenser through a methanol impinger, which acts as a sink for volatiles coming out of the reactor vessel.

14. The method of claim 12, wherein the chilled condenser contains chilled methanol at a temperature below room temperature.

15. The method of claim 1, wherein maintaining the dosed soil composition and the alkaline additive at the reactor pressure and the reactor temperature for a reaction period destructs more than 99 wt % of the PFAS present in the dosed soil composition.

16. The method of claim 1, wherein maintaining the dosed soil composition and the alkaline additive at the reactor pressure and the reactor temperature for a reaction period destructs more than 99.8 wt % of the PFAS present in the dosed soil composition.

17. The method of claim 1, wherein the reactor temperature is at or above a supercritical temperature.

18. The method of claim 1, wherein the reactor pressure is at or above a supercritical pressure.

19. A system for the destruction of per- and polyfluoroalkyl substances (PFAS) in soil, the system comprising:
(a) a sealed reactor vessel configured to contain a soil composition comprising PFAS;
(b) an oxidant delivery assembly configured to introduce into the reactor vessel an oxidant, wherein the oxidant is selected from the group consisting of hydrogen peroxide and compressed air;
(c) an additive delivery assembly configured to introduce into the reactor vessel an alkaline additive, wherein the alkaline additive is selected from the group consisting of sodium hydroxide and calcium hydroxide;
(d) a pressurization assembly comprising a pressurization valve and a pressure gauge, wherein the pressurization assembly is configured to pressurize the reactor vessel to a reactor pressure at or above 2000 psi;
(e) a heating assembly configured to heat the reactor vessel to a reactor temperature at or above 350° C.;
(f) a thermocouple assembly configured to monitor temperature inside the reactor vessel; and
(g) a venting assembly comprising a vent valve connected to the reactor vessel,
(i) wherein the sealed reactor is configured to maintain the soil composition, the oxidant, and the alkaline additive under the reactor pressure and the reactor temperature for a reaction period, and
(ii) wherein the sealed reactor is configured to destroy more than 90 wt % the PFAS present in the soil composition.

20. The system of claim 19, wherein the reactor vessel is operable to be pressurized to the reactor pressure in the range between approximately 2,000 psi and approximately 4,000 psi.

21. The system of claim 19, wherein the heating assembly is operable to be heated to the reactor temperature, wherein the reactor temperature is in the range between approximately 400° C. and approximately 500° C.

22. The system of claim 19, wherein the oxidant delivery assembly comprises a supply line connected to a hydrogen peroxide source having a concentration in the range between approximately 40 wt % and approximately 60 wt % in aqueous solution.

23. The system of claim 19, wherein the oxidant delivery assembly comprises a supply line connected to a compressed air cylinder.

24. The system of claim 23, wherein the compressed air cylinder is a high-pressure cylinder coupled with a regulator for delivering compressed air to the reactor vessel.

25. The system of claim 19, wherein the additive delivery assembly is configured to deliver sodium hydroxide to the reactor vessel.

26. The system of claim 19, wherein the additive delivery assembly is configured to deliver calcium hydroxide to the reactor vessel.

27. The system of claim 19, wherein the pressurization assembly and the heating assembly are jointly configured to maintain the reactor vessel at the reactor temperature and the reactor pressure for a reaction period in the range between approximately 0.5 hours and approximately 2 hours.

28. The system of claim 19, wherein the sealed reactor vessel is configured to contain the soil composition comprising soil selected from the group consisting of clay, sand, silt, loam, and combinations thereof.

29. The system of claim 19, wherein the dosed soil composition is a soil slurry that comprises between 25 wt % and 45 wt % solids.

30. The system of claim 19 further comprising a condenser connected to the venting assembly, wherein the condenser is operable for condensing off-gas released from the reactor through the venting assembly.

31. The system of claim 30 further comprising a methanol impinger, wherein the methanol impinger is operable to pass the off-gas cooled by the chilled condenser therethrough and act as a sink for volatiles coming out of the reactor vessel.

32. The system of claim 31, wherein the chilled condenser contains chilled methanol at a temperature below room temperature.

33. The system of claim 19, wherein the sealed reactor is configured to destroy more than 99 wt % the PFAS present in the soil composition.

34. The system of claim 19, wherein the sealed reactor is configured to destroy more than 99.8 wt % the PFAS present in the soil composition.

35. The system of claim 19, wherein the reactor temperature is at or above a supercritical temperature.

36. The system of claim 19, wherein the reactor pressure is at or above a supercritical pressure.
